(19) United States
(12) Patent Application Publication
(10) Pub. No.: US 2011/0236134 A1
(43) Pub. Date: Sep. 29, 2011

(54) CARBON DIOXIDE (CO2) AS CUSHION GAS FOR COMPRESSED AIR ENERGY STORAGE (CAES)

(75) Inventor: Curtis M. Oldenburg, Mill Valley, CA (US)

(73) Assignee: The Regents of the University of California, Oakland, CA (US)

(21) Appl. No.: 12/896,229

(22) Filed: Oct. 1, 2010

Related U.S. Application Data
(63) Continuation of application No. PCT/US2009/039281, filed on Apr. 2, 2009.
(60) Provisional application No. 61/041,887, filed on Apr. 2, 2008.

(51) Int. Cl. B65G 5/00

(52) U.S. Cl. 405/59

(57) ABSTRACT

The present invention provides for the utilization of a cushion gas in compressed air energy storage (CAES). In particular, the use of carbon dioxide (CO₂) as the cushion gas has been provided. Using CO₂ as the cushion gas enhances the effectiveness of the CAES by allowing greater amounts of compressed air to be stored and extracted.

### CROSS-REFERENCE TO RELATED APPLICATIONS

This application claims priority to PCT International Patent Application No. PCT/US2009/39281, filed Apr. 2, 2009, which claims priority to U.S. Provisional Patent Application Ser. No. 61/041,887, filed Apr. 2, 2008, which are hereby incorporated by reference.

### STATEMENT OF GOVERNMENTAL SUPPORT

The invention described and claimed herein was made in part utilizing funds supplied by the U.S. Department of Energy (DOE) under Contract No. DE-AC02-05CH11231. The government has certain rights in this invention.

### BACKGROUND OF THE INVENTION

1. Field of the Invention

The present invention relates to renewable energy sources and a method for increasing utilization of renewable energy. Particularly, the present invention relates to methods of improving and utilizing compressed air as energy by improving storage conditions.

2. Description of the Related Art

Renewable energy sources such as wind, solar, thermal, hydro, and biofuel have become more attractive as sources of energy due to the carbon dioxide emissions, rising cost, and rapid depletion of fossil fuels. However, there are intermittency and predictability problems associated with renewable energy sources because of the natural cycles of renewable energies, i.e. the generations required for crop growth relating to biofuels, seasonal climate changes, weather, and day and night cycles.

Additionally, since carbon dioxide gas exhausted from various sorts of industrial furnaces such as furnaces in thermal power plants has increased the temperature of the atmosphere on the earth, it becomes a great problem for mankind to prevent the temperature of the atmosphere from rising. As a method for preventing the temperature of the atmosphere from rising, several methods for storing or sequestering carbon dioxide gas have been utilized. One such method for the sequestering of carbon dioxide involves injecting the gas into the ocean, disused oil wells, mined cavities in rock salt, depleted natural gas reservoirs, or brine-filled aquifers (saline reservoirs).

### BRIEF SUMMARY OF THE INVENTION

The present invention provides for a method of utilizing a cushion gas (also known as base gas) for compressed air energy storage comprising: providing a reservoir, filling the reservoir with a predetermined amount cushion gas, and injecting compressed air into the reservoir, whereby the cushion gas will pressurize and serve as a cushion gas to store energy and force out the compressed air from the reservoir when needed. In a particular embodiment, the cushion gas is carbon dioxide (CO₂).

The present invention further provides for a method of storing compressed air comprising: providing a reservoir, filling the reservoir with a predetermined amount of cushion gas, and injecting compressed air into the reservoir, whereby the cushion gas serves to pressurize the reservoir and force the compressed air from the reservoir when extraction is needed. In a particular embodiment, the cushion gas is carbon dioxide (CO₂).

Additionally, the present invention provides for a method of enhancing compressed air energy storage output comprising: providing a reservoir, and utilizing CO₂ as a cushion gas, whereby the compressed air energy storage is enhanced by allowing more compressed air to be stored as compared to a reservoir using air or an inert gas as the cushion gas.

The present invention also provides for a method of sequestering carbon comprising: providing a reservoir, and filling the reservoir with a predetermined amount CO₂, whereby the CO₂ serves as a cushion gas for compressed air energy storage.

The present invention further provides for an underground gas storage reservoir comprising a predetermined amount of cushion gas and compressed air. In a particular embodiment, the cushion gas is carbon dioxide (CO₂).

The present invention also provides for a system useful as a compressed air energy storage comprising a reservoir, a predetermined amount of CO₂ useful as a cushion gas, and an air compressor to inject compressed air into the reservoir against the CO₂.

### BRIEF DESCRIPTION OF THE DRAWINGS

The foregoing aspects and others will be readily appreciated by the skilled artisan from the following description of illustrative embodiments when read in conjunction with the accompanying drawings.

FIG. 1 depicts an idealized single-well compressed air energy storage reservoir.

FIG. 2 depicts a graph showing the gas, liquid and supercritical phases of CO₂ with respect to pressure, temperature and depth. It shows that the CAES concept can be enhanced by using CO₂ as the cushion gas because of its supercritical state.

FIG. 3 shows data on the density and viscosity of CO₂ as a function of pressure up to 200 bars at three different temperatures (T=40° C., 60° C., and 80° C.) relevant to subsurface reservoirs.

FIG. 4 depicts a schematic of the Iowa Stored Energy Park, which is a wind-powered energy facility supplemented with a CAES.

### DETAILED DESCRIPTION OF THE INVENTION

Before the present invention is described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context clearly dictates otherwise. Thus, for example, reference to “reservoir” includes a plurality of such reservoirs, and so forth.

These and other objects, advantages, and features of the invention will become apparent to those persons skilled in the art upon reading the details of the invention as more fully described below.

### Compressed Air Energy Storage (CAES)

One approach to solving the intermittency issue of renewable energy sources is the use of compressed air energy storage. Compressed air energy storage (CAES) refers to the compression of air to be used later as an energy source. By compressed, it is meant to mean air which is kept under a certain pressure, usually greater than that of the atmosphere. Typical air pressure of the atmosphere at earth mean sea level is 1.01325 bar. Thus, compressed air has a pressure greater than 1.01325 bar. By air, it is meant to mean atmospheric gas, which is comprised approximately of the following: nitrogen 78.0842%, oxygen 20.9463%, argon 0.93422%, carbon dioxide 0.03811%, water vapor about 1%, and others 0.002%.

At utility scale, compressed air can be stored during periods of low energy demand (off-peak), for use in meeting periods of higher demand (peak load). CAES can be used to smooth the supply of intermittent and unpredictable renewable energy sources such as wind and solar energy. The key to smoothing energy supply is to store energy when the demand is less than the supply, and to deliver energy when demand is higher than the supply. This can be accomplished by using excess electricity when available to compress air, and injecting this air into underground storage reservoirs. In some embodiments, these storage reservoirs can be open caverns or porous rock formations, such as depleted natural gas reservoirs, aquifers, and mined caverns. When the demand for electricity increases, the air can be produced from the reservoir and fed into a gas turbine replacing between ¼ and ½ of the natural gas needed to run the turbine. Compressed air offers the following benefits over natural gas: (1) lower cost, (2) increased safety during storage and extraction, (3) more readily available, (4) easier to collect, and (5) renewability.

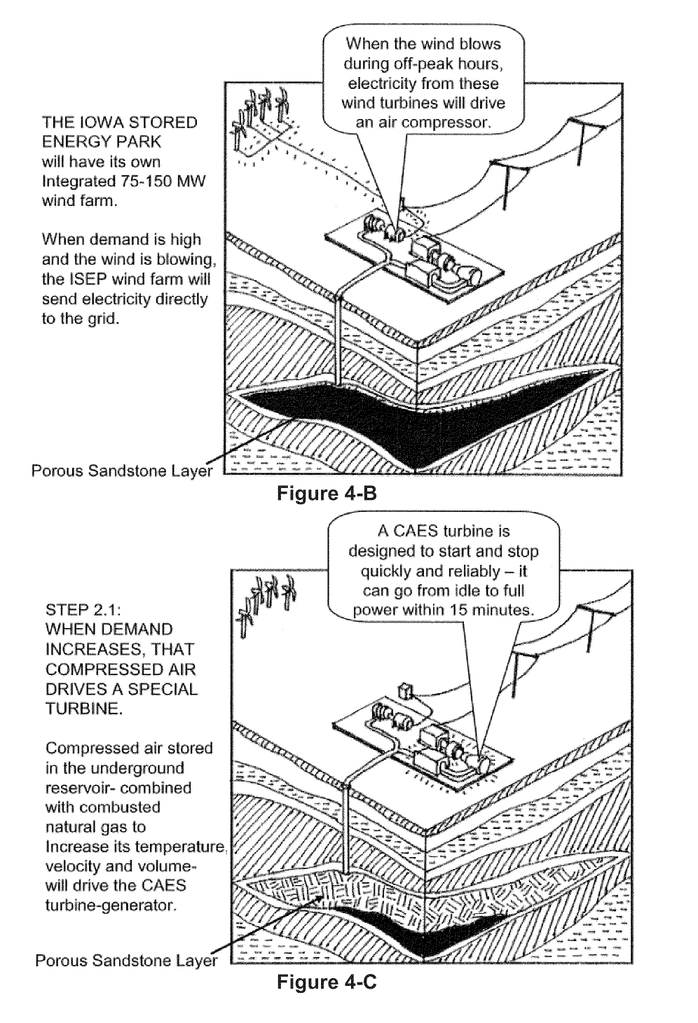

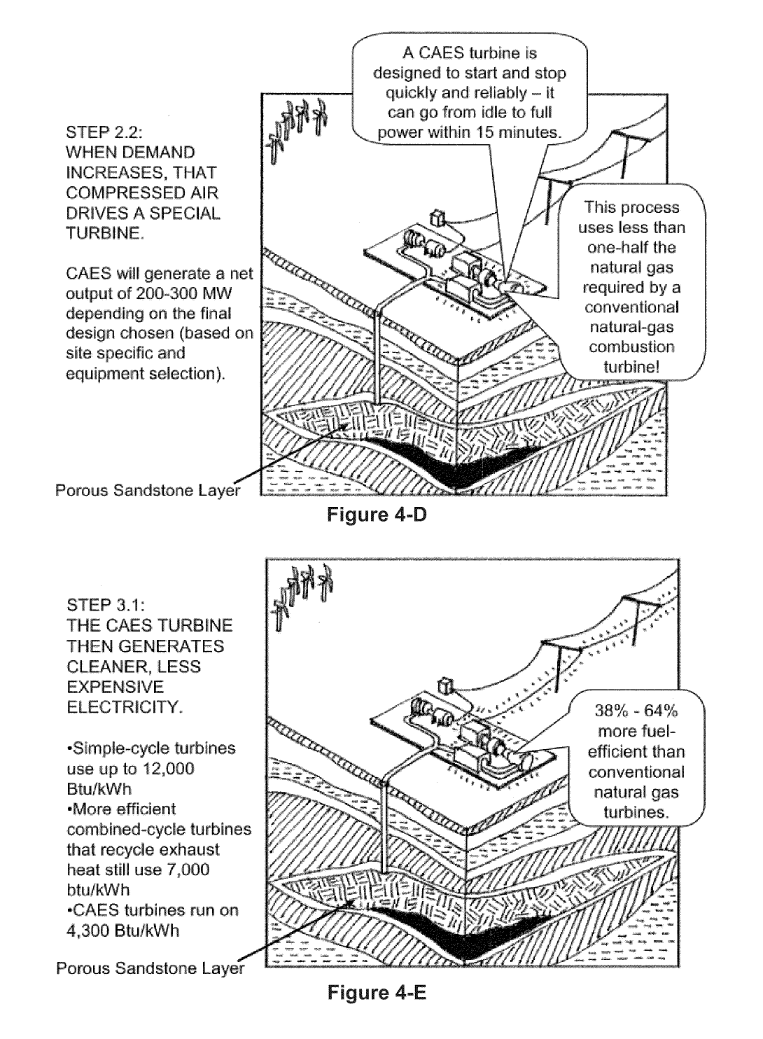

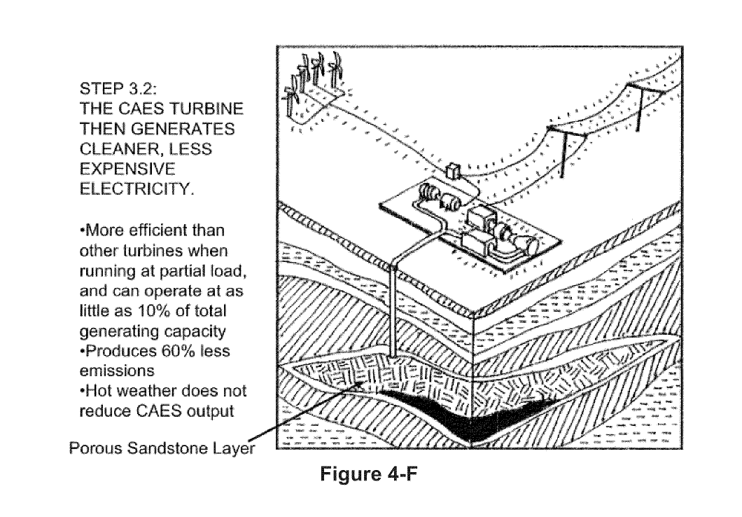

Referring now to FIG. 4, a schematic of the Iowa Stored Energy Park, which is a wind-powered energy facility supplemented with a CAES, has been shown. In FIG. 4(a), when the demand for energy is high and the wind is blowing, the wind farm will send electricity directly to the grid. In FIG. 4(b), when demand for energy is low, e.g. off-peak hours, and the wind is blowing, the wind farm will send electricity to drive an air compressor which will fill the porous sandstone layer with compressed air. In FIGS. 4(c) and 4(d), when demand is again high and there is no wind blowing, the compressed air stored in the underground reservoir (combined with combusted natural gas to increase the temperature, velocity, and volume) will drive the CAES turbine. In FIG. 4(e), the CAES turbine will provide power to the grid. In FIG. 4(f), in the case of very high demand, both the wind farm and the CAES can send energy to the grid.

### Carbon Dioxide (CO₂) as a Cushion Gas

Critical to the operation of CAES reservoirs is the use of a cushion gas, i.e., a gas that compresses and expands as the compressed air is injected or withdrawn but which is itself not produced. This is also sometimes called a base gas. A cross-section schematic of an idealized porous CAES reservoir is shown in FIG. 1. The injected air is referred to in FIG. 1 as the working gas. Production of air from the reservoir relies upon the presence of a cushion gas, the pressurization of which drives working gas out of the reservoir when needed. As the compressed air is injected against the cushion gas, pressure in the reservoir increases. Care must be taken not to over-pressurize the reservoir due to potential leakage and compromised integrity of the formation cap if the reservoir is over-pressurized. Similarly, as the compressed air is withdrawn and the pressure becomes low, there is a point when it is no longer feasible to produce the compressed air. Thus, the choice of cushion gas is important with regard to the amount of compressed air that can be stored and with regard to the amount of compressed air that can be extracted.

In typical CAES reservoirs, the cushion gas is most commonly air. However, inert cushion gases such as nitrogen (N₂) that are injected specifically for use as cushion gas have been used successfully. As indicated by the name “cushion,” compressibility is the key property of cushion gases. Because all gases are compressible, just about any gas can be used as a cushion gas. However, the efficiency of the gas storage operations can be increased if the cushion gas has greater effective compressibility.

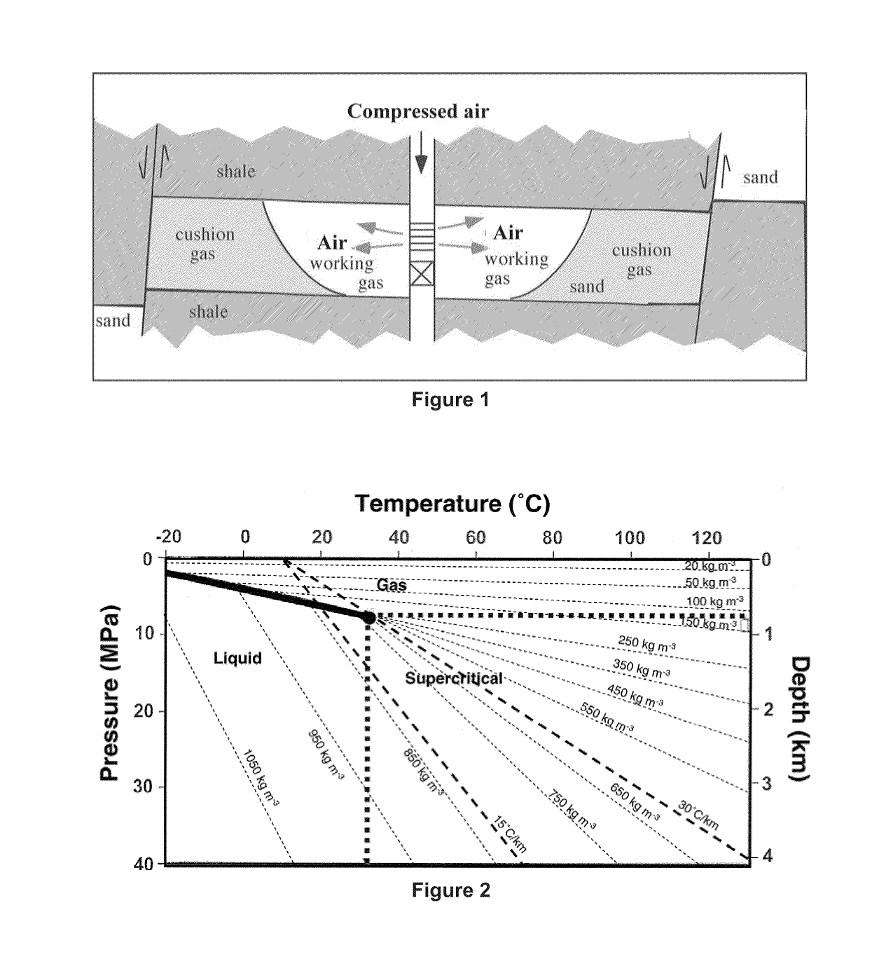

In a preferred embodiment, the cushion gas is carbon dioxide. CO₂ is an optimal choice as a cushion gas because of its high effective compressibility near its critical pressure. Shown in FIG. 2 is a graph showing CO₂ will be supercritical in a typical CAES reservoir at a depth of approximately 1 km. Specifically, because of the geothermal temperature and hydrostatic pressure gradients, CO₂ will normally be supercritical by virtue of temperature, and may be supercritical in terms of pressure depending on the depth and stage in the annual storage cycle.

Additionally, the present invention provides for the reduction of CO₂ released into the atmosphere by geologic carbon sequestration. The injection of CO₂ into an aquifer to create a CAES reservoir or the replacement of native gas by CO₂ in a potential CAES reservoir will effectively sequester carbon in the subsurface, a process that may earn carbon credits from government agencies (e.g., Reichle, et al., 1999; hereby incorporated by reference). Thus, there may be economic incentive for using CO₂ through carbon credits and tax advantages created to encourage carbon sequestration. Further, compressed air storage with CO₂ as cushion gas is a logical choice for use of gas reservoirs that have already been filled with CO₂ during the proposed process of carbon sequestration with enhanced gas recovery.

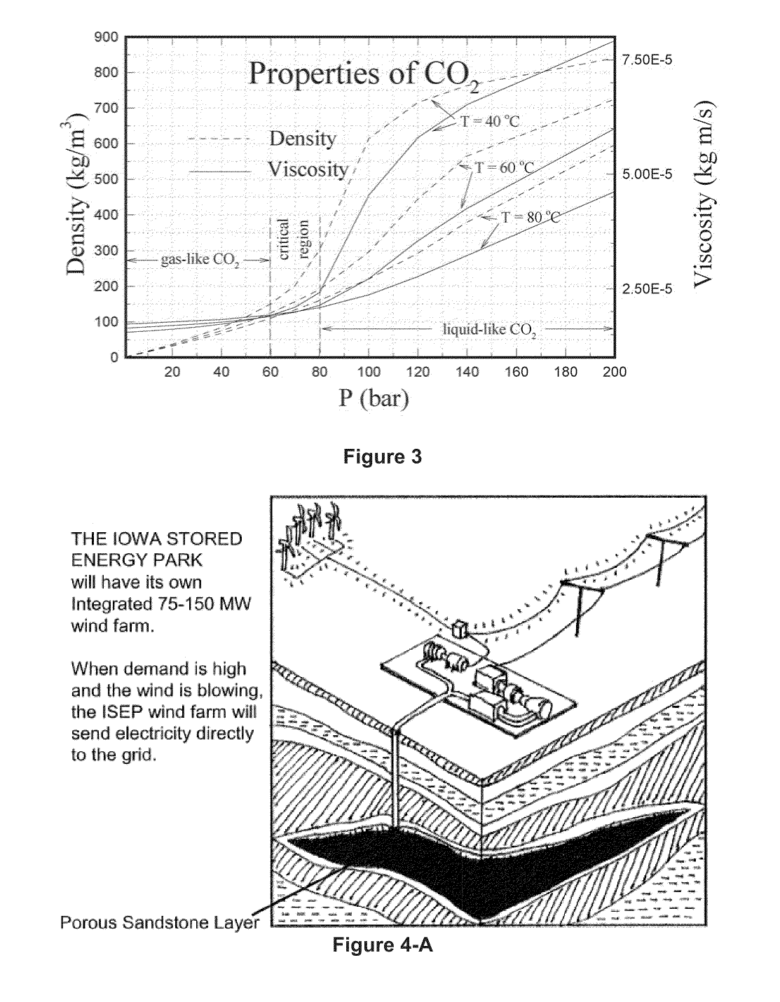

The density of carbon dioxide (CO₂) changes drastically around its critical point of 31° C. and 73.8 bars. Shown in FIG. 3 are data on the density and viscosity of CO₂ as a function of pressure at three different temperatures (T=40° C., 60° C., and 80° C.) relevant to subsurface reservoirs. For example as shown in the figure, when the pressure changes from 60 to 80 bars at 40° C., the density of CO₂ doubles, corresponding to a volume decrease of a factor of two. The density change is even greater for pressure changes from 50 to 120 bars.

In some embodiments, the use of CO₂ as a cushion gas will enhance the effectiveness of the CAES as compared to a CAES which employs air or an inert gas as the cushion gas. The use of CO₂ allows further compressibility which allows for more compressed air to be stored and because of the pressurization allows for more compressed air to be extracted when needed. When CO₂ is used as a cushion gas within the pressure range spanning the critical pressure, it allows larger quantities of compressed air to be injected with less increase in pressure than an inert cushion gas. Furthermore, when the compressed air is withdrawn and the reservoir pressure decreases, there is a corresponding larger gas drive due to the rapid decrease in density (i.e., increase in volume) of the CO₂ cushion gas.

In some embodiments, the use of CO₂ as an effective cushion gas for CAES operations is in the pressure range of about 10-200 bars, and more preferably in the range of 50-120 bars. In this range, the CO₂ cushion would supply ample expansion to force gas out under withdrawal, and provide a large volume contraction to accommodate air being injected.

In some embodiments, the use of CO₂ as a cushion gas is applicable to any suitable CAES operation where cushion gas is used, e.g., depleted natural gas reservoirs, aquifer storage, and salt cavern storage. In some embodiments, the replacement of existing native gas with CO₂ can be done analogous to the replacement of native gas by inert gas cushions (e.g., Laille et al., 1986; hereby incorporated by reference).

In some embodiments, the critical region of the CO₂-based cushion gas can be altered through the addition of other gas components to create a mixed cushion gas that is tuned to the desired pressure range of the storage reservoir. In some embodiments, the other gas components can be any other gas including but not limited to air or inert gases such as N₂, He, or Ne.

Mixing between the CO₂ cushion gas and the working gas will be minimal due to the larger density of CO₂ and the corresponding tendency for the CO₂ to remain below the lighter working gas. Insofar as mixing may occur, it will be analogous to the mixing that occurs in gas storage reservoirs with inert cushion gases (e.g., Carrière et al., 1985; hereby incorporated by reference). However, mixing may be inhibited by the large viscosity difference between CO₂ and air. Although CO₂ is more viscous than air, it is still quite inviscid, for example relative to water whose viscosity is approximately 10 times larger.

Additionally, in some embodiments, the mixing between the CO₂ cushion gas and the working gas can be reduced by the size and shape of the CAES reservoir. For example, in reservoirs with a large vertical extent relative to lateral (e.g. a vertically oriented solution-mined cavity), the density effect of the CO₂ could be exploited by placing the CO₂ deep in the reservoir and injecting and producing working gas from near the top.

In some embodiments of the invention, the reservoir comprises from 10 to 20% cushion gas by volume of the reservoir. In some embodiments of the invention, the reservoir comprises from 10 to 40% cushion gas by volume of the reservoir. In some embodiments of the invention, the reservoir comprises from 10 to 50% cushion gas by volume of the reservoir.

### The Reservoir

The reservoir used in the present invention can be any underground formation with connected void space, such as the open cavities provided by a mine or cavern, or the connected porosity in a saline formation, or a depleted hydrocarbon reservoir, whether this porosity is provided by intergranular space or fracture apertures. The volume intended for use needs to be isolated, e.g., by lower-permeability formations or features (e.g., sealing faults) or by connection to aquifers, so that it can be pressurized. The depleted hydrocarbon reservoir can be a depleted methane reservoir, also known as a gas field. The reservoir can be onshore or offshore. In some embodiments, the reservoir comprises a porous underground material. In some embodiment, the reservoir is at least 500 feet deep, that is, the ceiling of the reservoir is at least 500 feet deep. In some embodiment, the reservoir is at least 1,000 or 5,000 feet deep

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

### REFERENCES

Carrière, J. F., G. Fasamino, and M. R. Tek, Mixing in underground storage reservoirs, Society of Petroleum Engineers, SPE-14202, 9-12, 1985.
Katz, D. L., and M. R. Tek, Overview of underground storage of natural gas, Jour. Petrol. Tech. 943, June 1981.
Laille, J-P., C. Coulomb, and M. R. Tek, Underground storage in Cerville-Velaine, France: A case history in conversion and inert gas injection as cushion substitute, Society of Petroleum Engineers, SPE-15588, 1986.
Reichle, D. et al., Carbon sequestration research and development 2000, U.S. Department of Energy, DOE/SC/FE-1, 1999.
Vargaftik, N. B., N. B. Vinogradov, and V. S. Yargin, Handbook of Physical Properties of Liquids and Gases, Third Edition, Begell House, N.Y., 1359 pp., 1996.
Oldenburg, Curtis M., “Migration mechanisms and potential impacts of CO₂ leakage and seepage,” in Wilson and Gerard, editors, Carbon Capture and Sequestration Integrating Technology, Monitoring, and Regulation, pp 127-146, Blackwell Publishing 2007.
Oldenburg, Curtis M., Carbon Dioxide as Cushion Gas for Natural Gas Storage, Energy and Fuels 17, pp 240-246, 2003.

The references herein disclosed are hereby incorporated by reference for all purposes.

We claim:

1. A method of utilizing a cushion gas for compressed air energy storage comprising:
(a) providing a reservoir,
(b) filling the reservoir with a predetermined amount of cushion gas, and
(c) injecting compressed air into the reservoir,
whereby the cushion gas will pressurize and serve to force the compressed air from the reservoir when needed.

2. The method of claim 1, wherein the cushion gas is CO₂.

3. The method of claim 1, wherein the reservoir is an open cavernous formation, or porous or fractured rock formation.

4. The method of claim 3, wherein the open cavernous or porous rock formation is selected from the group consisting of a depleted natural gas reservoir, an aquifer, a solution-mined cavity, a disused oil well, and a rock salt mine.

5. The method of claim 1, wherein the predetermined amount of cushion gas provides that the cushion gas pressure is in the range of about 10 to 200 bars.

6. The method of claim 5, wherein the predetermined amount of cushion gas provides that the cushion gas pressure is in the range of about 50 to 120 bars.

7. The method of claim 2, wherein the CO₂ is mixed with at least one other gas.

8. The method of claim 7, wherein the other gas is an inert gas.

9. The method of claim 8, wherein the inert gas is N₂, He, or Ne.

10. A method of sequestering carbon comprising:
(a) providing a reservoir, and
(b) filling the reservoir with a predetermined amount CO₂,
whereby the CO₂ serves as a cushion gas for compressed air energy storage.

11. A system useful as a compressed air energy storage comprising:
(a) a reservoir,
(b) a predetermined amount of CO₂, wherein the CO₂ serves as a cushion gas for compressed air,
(c) and an air compressor, wherein the air compressor injects the compressed air into the reservoir.

12. The system of claim 11, wherein the reservoir is an open cavernous formation, or porous or fractured rock formation.

13. The system of claim 12, wherein the open cavernous or porous rock formation is selected from the group consisting of a depleted natural gas reservoir, an aquifer, a solution-mined cavity, a disused oil well, and a rock salt mine.

14. The system of claim 11, wherein the predetermined amount of cushion gas provides that the cushion gas pressure is in the range of about 10 to 200 bars.

15. The system of claim 14, wherein the predetermined amount of cushion gas provides that the cushion gas pressure is in the range of about 50 to 120 bars.

16. The method of claim 11, wherein the CO₂ is mixed with at least one inert gas.

17. The method of claim 16, wherein the inert gas is N₂, He, or Ne.
